(19) United States
(12) Patent Application Publication
(10) Pub. No.: US 2005/0182710 A1
(43) Pub. Date: Aug. 18, 2005

(54) Method of processing an electronic payment cheque

(75) Inventors: Sten Andersson, Lund (SE); Peter Kaarle, Furulund (SE); Anna Kapnoula, Lund (SE); Robert Elgaard, Gentofte (DK)

Correspondence Address: LADAS & PARRY, 26 WEST 61ST STREET, NEW YORK, NY, 10023, US

(73) Assignee: BEAMTRUST A/S, Ballerup (DK)

(21) Appl. No.: 10/506,939

(22) PCT Filed: Mar. 13, 2003
(86) PCT No.: PCT/DK03/00163

(30) Foreign Application Priority Data
Mar. 13, 2002 (DK) PA 2002 00387

(51) Int. Cl. G06F 17/60

(52) U.S. Cl. 705/39

(57) ABSTRACT

The invention relates to processing an electronic payment cheque that relates to a transfer of an amount of money from an account of a first user in a first banking institute to an account of a second user in a second banking institute, which processing includes generating digital signatures by means of asymmetric encryption. The method comprises the following steps:•in a first SIM card, creating an electronic payment cheque and signing the electronic payment cheque with a first signature;•transmitting the signed electronic payment cheque to a second SIM card in a second mobile equipment of the second user;•in the second SIM card, additionally signing the electronic payment cheque with a second signature;•transmitting the thus signed electronic payment cheque to subsequently initiate a deposit of the amount of money in the electronic payment cheque into the account of the second user.

This invention relates to a method of processing an electronic payment cheque that relates to a transfer of an amount of money from an account of a first user in a first banking institute to an account of a second user in a second banking institute, which processing includes generating digital signatures by means of asymmetric encryption using an asymmetric key pair comprising a private key and a public key.

A plurality of payment means are common today, such as bank notes and coins, cheques, money transfers from one bank account to another, credit cards, debit cards, giro transfer forms, etc. Some of these payment means are more suitable for transferring money from one person to another than others. The security of a money transfer is important; some persons do not want to carry big cash amounts, everybody prefers a security that a money transfer via a bank account or a giro account reaches the rightful receiver and when a payment means has an inherent protection against utilization, if unlawfully acquired, this is favoured.

Regarding money transfers, a solution which provides a secure and simple way of transferring money electronically from one person to another is desirable, for instance an electronic substitute of a cheque.

U.S. Pat. No. 5,677,955 describes a computer-based electronic instrument that can comprise an electronic substitute of a cheque. It is described, that the electronic instrument can be transferred from one computer to another and can relate to the transferral of funds from an account of a payer to an account of a payee. The electronic instrument can be signed by means of an electronic signature using asymmetric key cryptography, and by receipt of the electronic substitute of a cheque, the payee can deposit the cheque at his bank by means of the internet and/or e-mails.

Even though the electronic substitute of a cheque can be stored on a portable PCMCIA card, the use of the electronic substitute of a cheque is not mobile as such, in that it is limited to use in computers/PC's. Moreover, the electronic substitute of a cheque might be cumbersome to use in that the requirements for the information included are relatively high.

It would be desirable to be able to use an electronic substitute of a cheque in a mobile telephone for a number of reasons, viz. the inherent mobility of mobile telephones, the low power consumption and the fact, that many mobile telephones are substantially always turned on. The use of electronic substitutes of cheques has yet not been carried into effect on mobile telephones because the high security, that is necessary in connection with any transferral of money, including a transferral of a electronic substitute of a cheque, has not yet been obtainable.

Therefore there is a need for a secure method to transfer an electronic substitute of a cheque from a mobile telephone to another mobile telephone and/or to a bank.

The above and other objects are reached when the method mentioned in the opening paragraph is characterised in that the method comprises the steps of in a first SIM card of the first user, creating an electronic payment cheque and signing the electronic payment cheque with a first signature generated by means of a first private key of a first asymmetric key pair, which first private key resides on the first SIM card hosted by the first mobile equipment; via a first mobile equipment hosting the SIM card of the first user, transmitting the signed electronic payment cheque to a second SIM card hosted in a second mobile equipment of the second user; in the second SIM card, signing the electronic payment cheque, which has been signed with a first signature, with an additional second signature generated on the second SIM card, by means of a second private key of a second asymmetric key pair, which second private key resides on the second SIM card hosted by the second mobile equipment; transmitting the electronic payment cheque signed with the first and the second digital signatures from the second mobile station to a the central hub, which central hub is in communication with the first and the second banking institutes, and in the central hub, initiating a deposit of the amount of money in the electronic payment cheque into the account of the second user by initialising a verification of the second signature at the banking institution of the second user and a verification of the first signature at the banking institution of the first user.

When the creation and signing of the electronic payment cheque is performed on a SIM-card and the signing of a received electronic payment cheque for depositing/withdrawal thereof also is performed on SIM-card, a high level of security is obtained, because the interface between a SIM-card and a mobile equipment hosting it inherently limits the access to data on the SIM-card. Examples of the digital mobile telephone system used can be the Global System for Mobile communication (GSM) or Digital-American Mobile Phone Service (D-AMPS).

Preferably, the first and the second private key are generated on the first and the second SIM card, respectively, in the method according to the invention. When the private keys are generated on a SIM card and never have been exposed outside the SIM card, they are tamperproof.

In a preferred embodiment, the transmittal of the signed electronic payment cheque from the first mobile equipment hosting the SIM card of the first user to the second SIM card hosted in a second mobile equipment of the second user is performed via a digital mobile telephone system. In another preferred embodiment, the signed payment cheque is transmitted as a Short Message by means of IR, Bluetooth or Wi-Fi standards.

According to a preferred embodiment of the method, creating an electronic payment cheque comprises indicating a telephone number associated to the second SIM card, an amount to be transferred and an account index to the account, wherefrom the amount should be withdrawn. Thereby, the user of the first mobile equipment, i.e. the issuer of an electronic payment cheque, need only know the telephone number of the receiver of the cheque, i.e. the user of the second mobile equipment, the amount he/she wants to transfer to the receiver and from which account he/she wants to withdraw the money. The method supports the possibility that the issuer of the electronic payment cheque has a plurality of accounts to choose to withdraw money from, and preferably a default account is set, from which the money is withdrawn if the user do not change this setting.

When the signed payment cheque is transmitted as a Short Message by means of the Short Message Service system over the GSM system, the method provides a cheap, fast and simple way of money transfer.

Preferably, the method further comprises via the first mobile equipment, prompting the first user to confirm creation of an electronic payment cheque, which prompting is initiated at the first SIM card hosted by the first mobile equipment. Hereby, it is avoided that money transfers are generated unintentionally. Preferably, the conformation of the creation of the electronic payment cheque comprises entering of a PIN-RSA number. The PIN-RSA number is a PIN code of 4 digits, which is used to get access to the key files on the SIM card.

According to the invention, the encrypted electronic payment cheque is transmitted via a message proxy and preferably, the encrypted electronic payment cheque proxy is converted to an SMS Point-to-point data download message, which subsequently is transmitted to the second SIM card hosted by the second mobile equipment. The message proxy is an integrated part of the central hub.

The message proxy in the central hub is suitable for sending application specific messages from a banking institute via a bank application, typically also hosted in the BDC, to SIM cards hosted in mobile equipment. A BDC domain may consist of several Bank domains, i.e. several banks that are linked to the service of the BDC domain and are using the same BDC for processing of the transactions. The BDC domain can be divided into one BDC and several bank areas. The BDC is responsible for hosting some of the functionality that might be common between banks e.g. the Internet bank(s).

The other claims describe other preferred embodiments of the invention.

The term “mobile telephone” or “mobile phone” is used synonymous with “mobile station” and is used to define a mobile phone, which is divided in the two logical units: “mobile equipment” and “Subscriber Identity Module (SIM)”. The mobile equipment has all the functions for radio communication with the digital mobile telephone system. The mobile equipment together with the SIM thus equals the mobile station. Without the SIM, the mobile equipment is only able to perform emergency calls. The SIM card is a smart card that is used for storing of subscription related information.

The invention will be explained more fully below in connection with an example of a preferred embodiment and with reference to the drawing, in which:

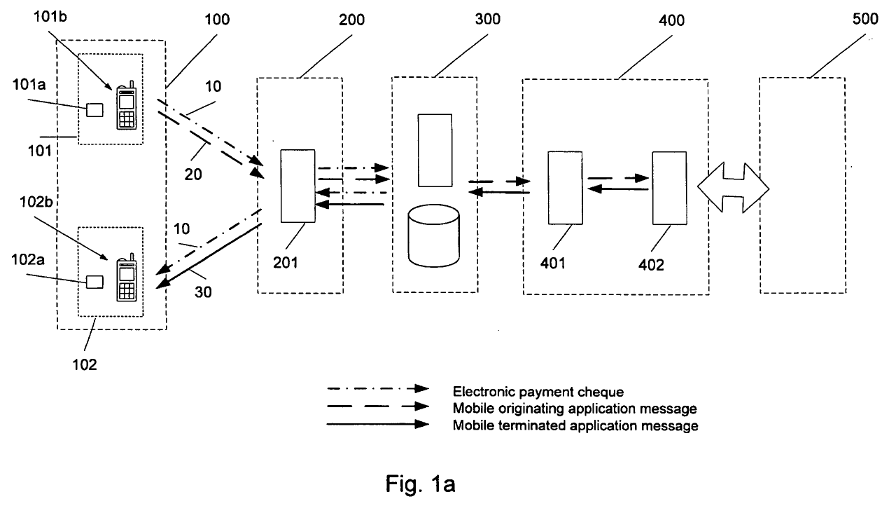

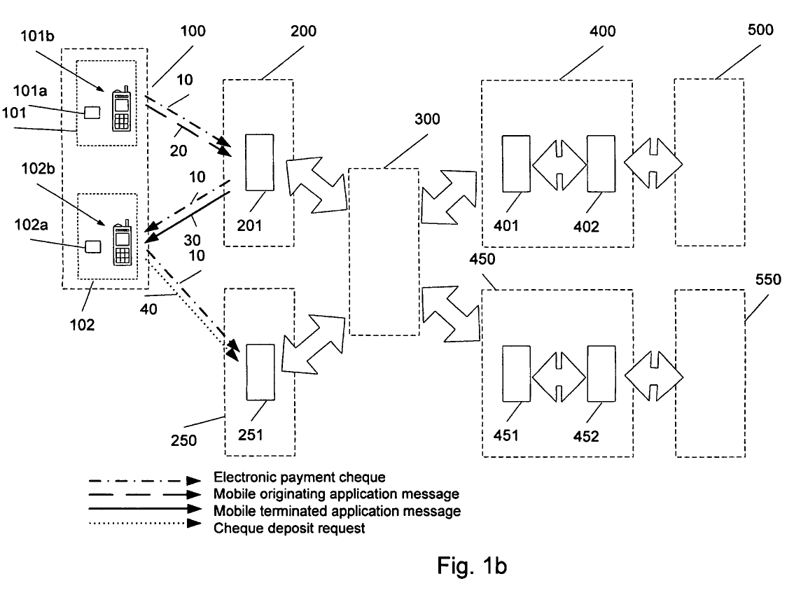

FIGS. 1a and 1b show overviews of the parts performing the method of the invention,

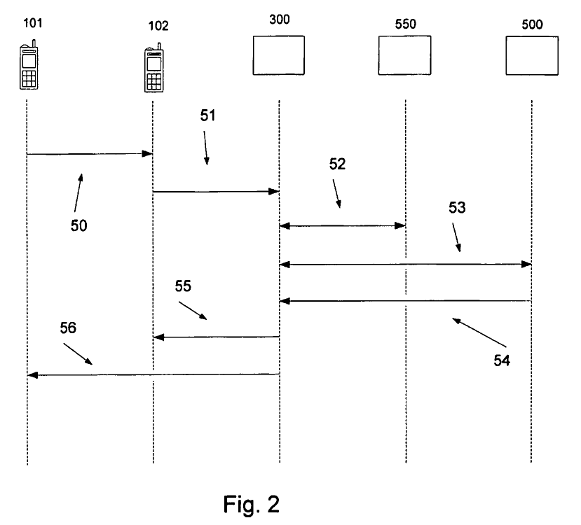

FIG. 2 is a diagram of the data flow between some of the parts performing the method of the invention, and

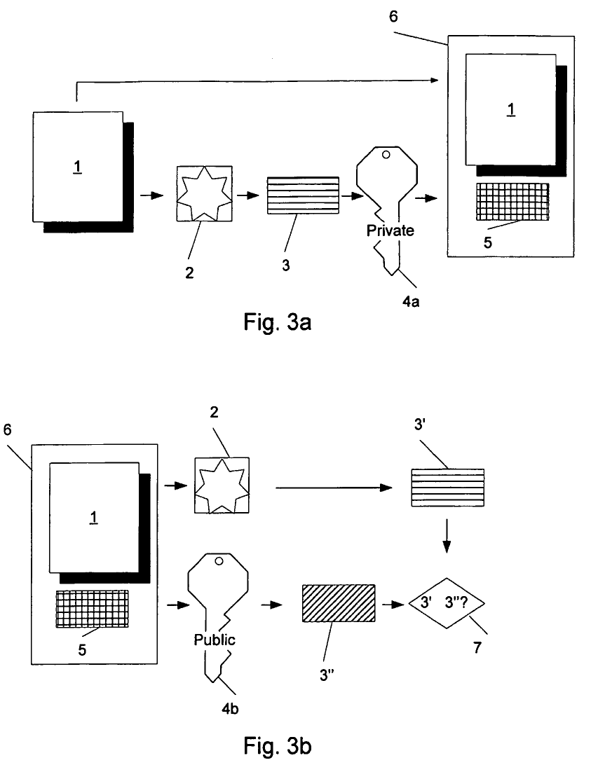

FIGS. 3a and 3b overviews of the digital signature calculation and the digital signature verification, respectively.

Throughout the figures, the same reference numbers refers to like elements.

FIG. 1a shows an example of an overview of the parts performing the method of the invention. The parts are shown hosted in a user's domain 100, an operator's domain 200, a central hub 300, a Bank Data processing Centre's (BDC domain) 400 and in a banking institute 500, respectively. Shown are to mobile telephones 101 and 102 operating in a digital mobile telephone system 100, whereof the mobile telephone 101 is an issuer of an electronic payment cheque and the mobile telephone 102 is the receiver thereof. This digital mobile telephone system 100 could be the Global System for Mobile communication (GSM) or Digital-American Mobile Phone Service (D-AMPS).

Throughout this description, the term “receiver” is meant to denote the mobile telephone 102, to which an electronic payment cheque is sent, and the term “issuer” is meant to denote the mobile telephone 101, from which the electronic payment cheque is sent. However, the terms “receiver” and “issuer” can also denote the user of the mobile telephone 102, to which an electronic payment cheque is sent, and the user of the mobile telephone 101 from which the electronic payment cheque is sent, respectively.

As stated above, the term “mobile telephone” or “mobile phone” is used synonymous with “mobile station” and is used to define a mobile phone 101, 102, which is divided in the two logical units: “mobile equipment” 101b, 102b and “Subscriber Identity Module (SIM)” 101a, 102a. The mobile equipment 101b, 102b has all the functions for radio communication with the digital mobile telephone system. The mobile equipment 101b, 102b together with the SIM 101a, 102a thus equals the mobile station 101, 102 respectively. In this description, the applications for performing the method of the inventions are placed on the SIM card; for facilitate the reading of this description, this is not always stated explicitly.

To use the method of the invention, i.e. activate the applications, a user has to register at the banking institute 500, typically through an Internet Bank, which will be explained below. After registration the user receives a new SIM card 101a, 102a from an operator 200, where the user is a subscriber. This SIM card 101a, 102a contains an application for supporting issuance and reception of electronic payment cheques according to the method of the invention. The SIM card 101a, 102a is preferably personalised to allow remote updates over the air (OTA). An activation procedure must be successfully executed before it is possible to use the service for performing the method according to the invention, and thereafter, the user can use the mobile equipment together with the customised SIM card 101a, 102a. The application on the SIM card 101a, 102a is responsible for signing electronic payment cheques and for the interaction with the user.

The OTA updates are performed by sending application specific messages from the Bank application 402 to the mobile phone 101, 102 via an SMS Gateway/Proxy 401 in the BDC's domain 400 and the operator's SMS-C 201. The application messages are transferred as user data within Short Messages and are transported between the mobile phone 101, 102 and the SMS-C 201 using mobile originated and mobile terminated short messages.

The BDC domain 400 has an interface to the central hub 300 and thereby to the operator's GSM environment. The SMS gateway 401 is responsible for communication with the SMS-C 201 within the operator domain 200 via the central hub 300. The Bank application 402 within the BDC domain 400 communicates with the SMS Gateway/Proxy 401 using an XML interface. With this interface it is possible for the BDC 200 to request OTA updates of application information on the SIM card 101a, 102a. The XML interface includes the receiver's phone number and a string to be sent either as an ordinary text message or an application message destined for the SIM application. The XML documents are sent between the Bank application 402 and the SMS Gateway/Proxy 401 using the HTTP method POST.

The SMS Gateway/Proxy 401 also has a service listening for mobile originated messages. This service handle all messages from mobile phones 101, 102 (independent of whether it's a mobile originating request or a response of a mobile terminated request) and delivers the messages as a XML document to the domain of the banking institute 500.

For information transmitted from the Bank application 402 to the SMS Gateway/Proxy 401, the Bank application 402 acts as an HTTP client and the SMS Gateway/Proxy 401 acts as an HTTP server. For information transmitted from the SMS Gateway/Proxy 401 to the Bank application 402, the reverse applies, i.e. the SMS Gateway/Proxy 401 acts as an HTTP client whereas the Bank application 402 acts as an HTTP server.

The information exchange, shown by arrows, between the issuer 101 and the receiver 102 of an electronic payment cheque is carried out over Short Message Service (SMS) with assistance from the central hub 300 and an SMS gateway/proxy server 401 in the BDC domain 400 of the issuer's bank and via an SMS centre SMS-C 201 in the operator's domain 200. The SMS gateway/proxy server 401 is supported by a bank application 302, which is in communication with the banking institute 500. The BDC domain 400 can be located within or in close proximity to the banking institute 500, but this is not necessary as long as the BDC domain 400 and the banking institute 500 are able to communicate.

The communication between the SMS Gateway/proxy 401, the central hub 300 and the SMS-C 201 is transparent to the Bank application 402. The SMS Gateway/proxy 401 within the BDC domain 400 is connected to the operator's SMS-C 201 using an SMS-C protocol, such as SMPP. The SMS-C 201 is responsible for sending short messages to the mobile phone upon request from the SMS Gateway/proxy 401 as well as forwarding short messages originated from the mobile phone to the SMS Gateway/proxy 401. The mobile originated short messages are addressed to a specific SME address, a so-called large account. The SMS-C maps the SME address to an address to the SMS Gateway/proxy 401 and forwards the message to the SMS Gateway/proxy 401 within the BDC domain 400. The sender of the message, i.e. the MSISDN of the mobile phone, must be transferred from the SMS-C 201 to the SMS Gateway/proxy 401 for further delivery to the Bank application 402.

In the above, the abbreviation SME denotes “Short Message Entity”, which is an entity capable of receiving and/or sending short messages. The SME can for instance be located in the mobile station or in a fixed network. The abbreviation MSISDN denotes the “Mobile Station International ISDN Number”, which is the standard international telephone number used to identify a given subscriber. The number is based on the ITU-T (International Telecommunications Union-Telecommunication Standardization Sector) E.164 standard. Finally, the abbreviation SMPP denotes “short message peer to peer”, where “Peer to peer” is a communications model in which each party has the same capabilities and either party can initiate a communication session.

The application messages are thus transferred as user data within short messages and are transported between the mobile phone and the SMS-C 201 using mobile originated and mobile terminated short messages. The SMS Gateway 401 also has a service listening for mobile originated messages. This service handle all messages from a mobile phone 101, 102 (independent of whether it's a mobile originating request or a response of a mobile terminated request) and delivers the messages as a XML document to the banking institute 500. The SMS gateway/proxy functionality has to be able to send a message, coded as an SMS Point-To-Point Data Download message, from one mobile phone to another.

The requirements on the SMS gateway/proxy 401 are explained closer in the following. The SMS gateway/proxy 401 must be able to cheque all messages originating from a mobile station 101, 102. Depending on the message type, the SMS gateway/proxy 401 should either route the message to the banking institute 500 or forward the message to another mobile phone 101, 102. The messages shown in FIG. 1 from or to a mobile telephone includes the electronic payment cheque 10, the mobile originating application message 20 and the mobile terminated application message 30. Of course, Short Messages (SM) sent from one mobile telephone 101 to another 102 can in general comprise text messages; however, those are not shown in FIG. 1 since they are not in the interest of the invention.

On messages sent from one mobile phone 101 and forwarded to another mobile phone 102. The SMS gateway/proxy 401 should perform the following:
Take the phone number of the receiver 102 from the mobile originating application message 20 and put it in the SM header as the Destination Address.

Take the Originating Address from the mobile originating SM header and put it in the application message as a parameter for the sender's (issuer's) phone number.

Preferably, append the actual date from the gateway/proxy server to the application message as a parameter. Hereby the electronic payment cheque is provided with a cheque issue date providing the option that a cheque is valid for a limited time period set by the bank. A cheques' valid time can then be counted from the time the cheque is sent i.e. the date when it passes the SMS Gateway/proxy server 401 of the issuer's banking institute 500.
Code the mobile terminated message as SMS Point-To-Point Data Download (SMS PP DD) messages. This enables the Mobile equipment to transparently forward the short messages to the SIM.

FIG. 1b shows the elements from FIG. 1a in conjunction with the domain 250 of an operator of the receiver, a domain 350 of a Bank Data processing Centre (BDC domain) of the receiver of the electronic payment cheque and a banking institute 550 of the receiver, respectively. The operator's domain 250 comprises an SMS centre SMS-C 251, and the BDC domain 350 of the receiver's banking institute comprises an SMS gateway/proxy server 351 and a bank application 352. Hollow arrows in FIGS. 1a and 1b indicate that some communication can take place, without specifying this communications further.

When a receiver 102 has received an electronic payment cheque, he/she can deposit it in a bank account in his banking institute 550. For this purpose, the receiver sends an SMS from the mobile telephone 102 to his/her banking institute 550 via the SMS-C 251, the hub 300, the SMS gateway/proxy server 451 and the bank application 452 to the banking institute 550. This SMS contains the electronic payment cheque 10 and a cheque deposit request 40. After receipt of the cheque deposit request 40, the banking institute 550 initiates a communication with the banking institute 500 of the issuer to carry a transfer of money indicated in the electronic payment cheque from the issuer's account to an account of the receiver into effect. The details of this communication are described below.

The receiver 102 has received the electronic payment cheque with the telephone number of the receiving mobile telephone 102, the amount to be transferred from the issuer to the receiver and the issuer account, from which the money should be withdrawn together with the digital signature generated by the application on the SIM of the mobile telephone 101; additionally the SMS gateway/proxy 301 automatically appends the MSISDN of the issuing mobile telephone 101. Thereby the issuer of the electronic payment cheque can be presented unambiguously to the receiving mobile telephone 102. The SMS gateway/proxy 301 also adds a date stamp, which provides an issue date to the electronic payment cheque.

The receiver initiates a signing of the electronic payment cheque with a second digital signature, and the electronic payment cheque, thus signed with the first and the second digital signatures is transmitted from the second mobile station 102 to the central hub 300. The hub 300 performs the following processing:

Sends the part of the cheque, which is signed by the second user 102 to the banking institution 550 of the second user 102. The banking institution 550 of the second user 102 verifies the signature and, on basis of the GSM number and account index of the second user 102, returns the corresponding account number.

The central hub 300 attaches the real account number received from the banking institute 550 of the second user 102 to the part of the transaction, which is signed by the first user 101. This data is sent to the banking institute 500 of the first user 101. The banking institute 500 of the first user verifies the signature from the first user and determines whether sufficient funds exist in the account indicated by the telephone number (e.g. the GSM number) and account index of the first user 101. If sufficient funds exist in the account of the first user 101, the banking institute 500 of the first user 101 initiates a transfer to the second user's account in the second banking institute 550. The banking institute 500 of the first user 101 sends a reply back to the central hub 300. If the reply is a reject, the central hub 300 sends a short message to both the first and the second user 101, 102 with information, that the transfer has been rejected. If the reply is an acknowledgement, the central hub 300 sends an application type SMS to the second user 102, which application type SMS erases the check from the SIM card of the second user 102.

No matter whether the reply is a reject or an acknowledgement of the transfer of money, the receiver of the electronic payment cheque is notified thereof substantially without delay. Likewise the receiver of an electronic payment cheque is notified of the reception substantially without delay from the receipt.

Even though only two users, BDC's, two banking institutes are shown, it should be understood, that substantially any number of users in the user domain can perform the method of the invention. Moreover a plurality of BDC's, banking institutes, SMS centres could be used in the implementation of the invention.

The application on the SIM card of a user for implementing the method of the invention supports issuance of cheques from a plurality of accounts in different banking institutes; a user have activated the service for implementing the method in e.g. 5 different banks for use of a total of 10 accounts.

FIG. 2 is a diagram of the data flow between some of the parts performing the method of the invention. FIG. 2 shows that cheque issuer data 50 are sent from a mobile telephone 101 of the issuer a second mobile telephone 102 of the receiver of the electronic payment cheque. The cheque issuer data 50 includes at least the electronic payment cheque, the telephone number of the receiving mobile telephone 102, the amount to be transferred from the issuer to the receiver and the issuer account, from which the money should be withdrawn. The cheque issuer data also contains a digital signature generated by the application on the SIM of the mobile telephone 101. The cheque issuer data 50 have thus been confirmed and signed by the issuer before sending and is sent via SMS. The cheque issuer data 50 are sent via the SMS gateway/proxy 301 (not shown in FIG. 2) of the issuer, which SMS gateway/proxy receives the SM, recodes and forwards it to the receiving mobile telephone 102.

When the receiver 102 wants to deposit a received cheque to a bank account, it can also be done via SMS. The receiver 102 enters the appropriate application on the SIM card of the mobile telephone 102 via the appropriate menu entry in the service menu and is presented with a list of all received cheques. In the next interactions the receiver 102 chooses a cheque that should be deposited and, if no default account is set, also chooses the account to which it should deposited, and he/she enters the personal service PIN code, the PIN-RSA, to allow the transaction to be signed.

Before a cheque deposit request 51 is sent from the receiver 102, a summary of the collected information is displayed to the receiver 102. The information displayed is amount, account nickname, date and a reference number. The reference number shown is a transaction identifier concatenated with the signature identifier. The user confirms and digitally signs the summary and the cheque deposit request 51 is transmitted to the central hub 300. Thus, the cheque deposit request 51 includes both the signature of the receiver of the cheque and the signature of the issuer of the cheque.

The central hub 300 initiates a data communication 52 to the banking institution 550 of the second user 102. The central hub 300 sends the part of the cheque, which is signed by the second user 102 to the banking institution 550 of the second user 102 in the data transmission 52, and the banking institution 550 of the second user 102 verifies the signature and, on basis of the GSM number and account index of the second user 102, returns the corresponding account number to the central hub 300.

The central hub 300 attaches the real account number received from the banking institute 550 of the second user 102 to the part of the transaction, which is signed by the first user 101. This data is sent to the banking institute 500 of the first user 101 in a data transmission 53. The banking institute 500 of the first user verifies the signature from the first user and determines whether sufficient funds exist in the account indicated by the telephone number (e.g. the GSM number) and account index of the first user 101. If sufficient funds exist in the account of the first user 101, the banking institute 500 of the first user 101 initiates a transfer (not shown) to the second user's account in the second banking institute 550.

The banking institute 500 of the first user 101 sends a reply 54 back to the central hub 300. If the reply 54 is a reject, the central hub 300 sends a short message 55, 56 to the first and the second user 101, 102, respectively, with information, that the transfer has been rejected. If the reply is an acknowledgement, the central hub 300 sends an application type SMS 55 to the second user 102, which application type SMS 55 erases the check from the SIM card of the second user 102.

The generation of digital signatures by means of asymmetric encryption using an asymmetric key pair comprising a private key and a public key is well known per se, but its use in connection with the invention will be described in the following with reference to FIGS. 3a and 3b.

Asymmetric encryption systems, or public key systems, use two different keys, a public key 4b and a private key 4a, for encryption and decryption. The two keys 4a, 4b are dependent on each other and form a personally unique key pair, but it is not possible to calculate one key from knowledge of the other. Either the public or the private key can be used for encryption. The decryption is then made with the corresponding key of the key pair. For example, a message encrypted with a recipient's public key can be decrypted only with the same recipient's private key. The RSA (Rivest, Shamir, Adleman) algorithm is today a de facto standard for public key systems.

Hash algorithms 2 are used to create a digital fingerprint, or a message digest of a certain piece of information. Even the slightest change in the original message document produces a completely different digital fingerprint. A MAC (Message Authentication Code) is a hashed message encrypted using a symmetric key. A MAC gives message integrity but not non-repudiation. SHA-1 is a commonly used hash algorithm. It produces a 20-byte message digest of any input message.

A digital signature is created in the following way:
An original message 1 is hashed with a hash algorithm 2 (e.g. SHA-1) and the digital fingerprint 3 of the original message is created.
The fingerprint 3 is encrypted with the sender's private key 4a.

The result is a digital signature 5 that is unique for every combination of message 1 and private key 4a. The message 1 and the digital signature 5 form an entity 6.

Upon reception, the digital signature 5 is verified in the following way:
The original message in the entity 6 containing the original message 1 and the digital signature 5 is run through the hash algorithm 2 that was used in creation of the digital signature 5, thereby providing a digital fingerprint 3′.

The signature 5 is decrypted with the sender's public key 4b, providing a decrypted, digital fingerprint 3″.

The digital fingerprint 3′ and the decrypted, digital fingerprint 3″ are compared at 7. If they are identical, the digital signature 5 is valid.

Digital signatures provide the following:
Authentication of the sender's identity.

Assurance that any changes to the message will be noticed (integrity).

Assurance that the sender can not deny sending the message (non-repudiation).

In the method of the invention, the concepts introduced above are used to create secure transactions.

During the activation process of the service for performing the method of the invention, which will be described below, an RSA key pair is generated on the SIM card. The private key is stored in a tamperproof area on the SIM card, and the public key is exported from the mobile phone to the server in the BDC domain. In return, the server sends its own public RSA key to the mobile phone. All RSA keys (both end-user and BDC keys) have a 1024-bit modulus and a public exponent set to 2\hat{ }16+1 (=65537).

In order for the server to be able to authenticate the sender of the public key, the user has previously received a One-Time-Password (OTP) from the server on a secure, separate channel (e.g. via Internet Bank). The application on the SIM card calculates a message digest using SHA-1. The input is a concatenated string of all the information sent in the message (including the public key) and the OTP. The generated message digest is 20 bytes, but it is truncated to the first 8 bytes to create an Authentication Code.

The public key together with the other information and the Authentication Code are exported to the BDC domain. The total length of the message will be 139 bytes (1 byte Message Type+1 byte Protocol Version+1 byte SIM Application Version+128 bytes Public Key+8 bytes Authentication Code), which can be sent in one SM.

The server can then calculate an Authentication Code in the same way on the known OTP and the received information. If a comparison with the received Authentication Code is successful, it can be assumed that the public key has not been corrupted during transfer and that it indeed originates from the user. If the public key of the user is accepted, the server sends the public key belonging to the BDC domain, which will be used for server authentication purposes in subsequent operations. The message contains a new Authentication Code, which makes it possible for the application on the SIM card to verify that the message is originated from the correct source. It also contains an BDC identifier BDC-ID, which is used by the phone to link the public key to the correct BDC (in a multiple BDC scenario). The Authentication Code is again the first 8 bytes of a message digest calculated using SHA-1. The input is a concatenated string of all the information sent in the message (including the public key) and the OTP.

The public key together with the other information and the Authentication Code are sent to the mobile phone. The total length of the message will be 138 bytes (1 byte Message Type+1 byte BDC-ID+128 bytes Public Key+8 bytes Authentication Code), which can be sent in one SM. The application on the SIM card can then calculate an Authentication Code in the same way on the known OTP and the received information. If the comparison with the received Authentication Code is successful, it can be assumed that the public key has not been corrupted during transfer and that it indeed originates from the BDC.

In order for the mobile phone to be able to trust OTA updates and requests from the BDC domain, a mechanism for server authentication is needed. All information in messages from the server is encrypted using RSA with the BDC's private key according to Public Key Cryptography Standards. This creates a signature, which makes it possible for the application on the SIM card to perform server authentication upon reception of the message. In addition to the application information, the signed message contains the Message Type, the BDC identifier and a sequence number.

Note, that the Message Type and the BDC identifier are also sent unencrypted to the mobile phone, as they are needed by the SIM application before the signed message has been verified (decrypted). The Message Type is used to determine how the message should be handled. The BDC identifier is used to select the public key that should be used to decrypt the message.

The sequence number is a 3-byte integer generated by the BDC, which must be incremented for each new operation that the BDC requests towards a specific user, i.e. a separate counter is used for each user.

Before the encryption operation, the information has to be padded to 128 bytes. Since no hash of the message is calculated, the hash algorithm identifier will not be included. Basically, the padding is performed in the following way:
Construct a padding string consisting of (128-[length in bytes of data to sign]-3) octets with the hexadecimal value FF.
Concatenate the padding string, the message to be signed, and delimiters to form the padded message

The padded message is then signed by the BDC by encrypting the information with the private key of the BDC. When the message is received, the SIM application performs the following steps:
The message is decrypted using RSA with the BDC's public key. The BDC-D is used to select which public key is used to decrypt the message.

The padding is checked to verify that the information has not been changed after it was signed, and then removed to recover the signed data. For additional security, the BDC-ID and the Message Type in the signed message can also be compared to the BDC-ID and the Message Type that were sent unencrypted to verify that the information has not been changed.

The sequence number is compared to the sequence number received with the latest OTA request, in order to prevent replay attempts. The number must be incremented by the server for each new OTA request.

Mobile transactions initiated by the user are signed and can be listed as follows:
Issue cheque (via SMS)
Deposit cheque (via SMS)

The transactions are signed using RSA according to Public Key Cryptography Standards.

Below, the parameters and their order as they are signed during the transaction are outlined. The SHA-1 hash is calculated on the following concatenated data in each transaction.

Issue Cheque

| | |
|---|---|
| MSISDN_receiver | (20 bytes) |
| BDCID_issuer | (1 byte) |
| AccountID_issuer | (1 byte) |
| ChequeAmount | (15 bytes) |
| ChequeID | (3 bytes) |

The format on the telephone number of the receiver, MSISDN_receiver, when signed is the complete international phone number, entered by the user, without the leading ‘+’ or “00” string.

Deposit Cheque

| | |
|---|---|
| BDCID_receiver | (1 byte) |
| AccountID_receiver | (1 byte) |
| SignID | (3 bytes) |
| ChequeIssueDate | (8 bytes) |
| Signature_issuer | (128 bytes) |

In the transaction summary a 7-digit reference number (RefNo) is displayed to the user. The RefNo is usually a 4-digit transaction identifier (TrxID) concatenated with the user's 3-digit signature identifier (SignID). During a deposit cheque transaction, however, no interaction with a pay-box takes place and no TrxID can therefore be received. To keep the RefNo in a uniform format to the user the TrxID is in this operation replaced with a dummy value (“0000”) which is not signed.

In signature calculation, the 20-byte result of the SHA-1 operation above is padded to 128 bytes and encrypted using RSA with the user's private key.

The padding is done according to the EMSA-PKCS1-v1_{—}5 encoding operation. Basically, the padding is performed in the following way:
Hash the message using SHA-1.
Construct a SHA-1 hash algorithm identifier using DER (Distinguished Encoding Rules). This results in the following octet string:
   30 21 30 09 06 05 2b 0e 03 02 1a 05 00 04 14
Construct a padding string consisting of 90 octets with the hexadecimal value FF.
Concatenate the padding string, the algorithm identifier, the hashed message, and delimiters to form the padded message:
00∥01∥FF FF [ . . . 86xFF . . . ] FF FF∥00∥30 21 30 09 06 05 2b 0e 03 02 1a 05 00 04 14∥ [hashed message]

The signature verification is done in the following way:
Hash the original transaction using SHA-1 and apply the padding described above.
Decrypt the signature using RSA and the user's public key.
Compare the hashed and padded transaction with the decrypted signature. If they match, the signature is valid.

The user registration, i.e. the activation of the applications on the SIM card, will be described below. The registration described takes place via an Internet bank. It is presumed, that the user has received a new SIM card from the operator and has been instructed to activate the service for performing the method of the invention through the Internet Bank. Therefore, it is implicitly presumed, that the user is a registered user of an Internet Bank and that a trusted relationship thus already exists between the user and the bank. Moreover it is presumed, that the user has registered to the service for performing the method of the invention via the Internet Bank, and that the bank thereafter has sent a request to an operator for issuing and distributing a new SIM card supporting the applications for performing the method of the invention to the user. Moreover, it is presumed, that the mobile telephone is switched on and the new SIM card is inserted.

The user selects a menu choice in the Internet Bank for activation of the service for performing the method of the invention. Then an 8-digit One-Time-Password (OTP) is displayed to the user on the screen. This information is used in the SIM application to provide user authentication and initiate the key generation. The user is instructed to select the menu choice for activation of the service for performing the method of the invention on the mobile phone.

The user selects an option “Service activation” in the menu on the mobile phone and enters the OTP. Entering the OTP triggers generation of the RSA key pair on the SIM card. The private key is stored in a tamperproof location on the SIM card. The application on the SIM card calculates an Authentication Code. The input is all information in the message, i.e. the message type, the OTA protocol version, the SIM application version, and the public key of the user, concatenated with the OTP. The generated 8-byte Authentication Code is then sent together with the other parameters in a SM to the BDC domain.

Note that an SME address (phone number) is needed on the SIM card to send messages to the BDC domain. The SME address can be pre-configured on the SIM card, but in a multiple BDC environment, the SME address may preferably be displayed to the user on the computer screen together with the OTP, and then entered into the mobile phone after the OTP.

Before the public key is accepted for use within the BDC domain, the Authentication Code received from the mobile phone is compared with an Authentication Code calculated locally in the BDC domain on the same parameters. If the comparison is successful the public key is stored.

If the public key of the user is accepted, the BDC domain exports its own public key, which will be used for server authentication purposes in subsequent operations. The message contains a new Authentication Code, which makes it possible for the application on the SIM card to verify that the message is originated from the correct source. It also contains the BDC-ID, which is used by the phone to link the public key to the correct BDC (in a multiple BDC scenario).

The Authentication Code is calculated, and the input is all information in the message, i.e. the message type, the BDCID, and the public key of the BDC, concatenated with the OTP. The generated 8-byte Authentication Code is then sent together with the other parameters in a SM to the mobile phone.

When the message is received, the application on the SIM card validates the Authentication Code by comparing it with an Authentication Code calculated locally in the mobile phone on the same parameters. If the validation is successful, the public key is stored and the BDC domain is notified of the result.

The BDC domain then sends a message to the mobile phone containing the information required for configuration of the application on the SIM card. The information package is signed (encrypted) with the BDC's private key before it is sent to the mobile phone. This makes it possible for the SIM application to perform server authentication upon reception of the message.

In addition to the application information, the signed message contains the Message Type, the BDC-ID and a sequence number. The Message Type and the BDC-ID are also sent unencrypted, as the SIM application needs these parameters in order to handle the message. The message is then signedError! Reference source not found.

When the message is received, the SIM application verifies the signed message and checks the sequence number. The BDC-ID is used to select the public key that should be used to verify the message.

If the validation is successful, the application data is stored and the BDC domain is notified of the result. The sequence number received in the request from the BDC is returned in the response and could be used on the server side to link the result to the corresponding request.

The user is requested to select a PIN code of 4 digits, which will be used to get access to the key files on the SIM card. This PIN code is referred to as PIN-RSA herein. Finally, the user is informed that the service for performing the method of the invention has been activated through a text message on the mobile phone display.

A useful functionality that can be provided by the central hub is to handle a cheque book via a web server. When a user sends a cheque to another user, the transmission passes through the central hub and the SMS-server. When the central hub registers the cheque, it can send a “Cheque issued” message to the web server. The “cheque issued” message contains the telephone number of the issuer and of the receiver, account index, cheque identification, the amount of money to be transferred and the date. The web server writes these data in a cheque book table.

When the receiver of an electronic payment cheque deposits the cheque, this will be performed via the central hub. When the central hub receives an acknowledgement of the transfer of money from the issuer's banking institute, the central hub sends a “cheque cleared” message to the web server. This “cheque cleared” message contains cheque identification, the telephone number of the issuer and of the receiver, the amount of money to be transferred and the date. The web server puts this cheque into a “cheque cleared” table. Hereby, the issuer as well as the receiver automatically has an updated cheque book of issued and received cheques.

Via a web interface a user (i.e. an issuer and/or a receiver) can connect to the web server and see all issued cheques. For instance, the following five possibilities might exist: “All cheques”, “cleared cheques”, “issued cheques”, “received cheques” and “cashed cheques”.

“All cheques” shows a list of all the cheques the user have issued and/or received with the status thereof (deposited or not deposited at an account in a banking institute). “Cleared cheques” shows a list of the cheques that the user has sent and which have been deposited by the receiver(s) thereof. “Issued cheques” shows a list of the cheques that the user has sent but which have not been deposited yet by the receiver(s) thereof. “Received cheques” shows a list of the cheques that the user has received but which have not yet been deposited and “Cashed cheques” shows a list of the cheques that the user has received and which have been deposited at an account in a banking institute. The facility “Cleared cheques” provides the user with the possibility to determine whether a cheque has been deposited, which could be of relevance in the situation of a receiver asserting not to have received the cheque. If a receiver asserts not to have received a sent cheque, the cheque can be retransmitted. This re-transmittal is secure, in that the banking institute would reject any duplicate cheques.

Moreover, this cheque book service can include general filtering mechanisms such that a user can choose only to see cheques issued and/or received within a chosen time interval, from and/or to chosen telephone numbers, etc.

A cheque will expire after a specified number of days. The web sever can notify a user who has an “un-cashed” cheque, when the expiration date thereof is approaching by means of a Short Message.

Above, it has been explained that messages can be sent as Short Messages via the SMS service. However, due to the large amount of information and the signature in a cheque, a cheque issued and sent from an issuer to a receiver has to be sent as two short messages. The signature of the first user is split into two parts and the cheque is then sent as two SM, with one part of the signature in each. To be able to associate the messages again on the receiver's side each message must contain a reference to the other part of the message; this parameter is called the MessageReference and is a one-byte counter that is unique for each user. Both messages must include the phone number (MSISDN) of the receiver to allow the SMS proxy to forward the messages to the receiver. The second part of the cheque sent from the issuer to the receiver, containing the second part of the signature.

As explained in detail above, the deposit of a cheque issued by an issuer and sent to a receiver at the banking institute of the receiver can be started up by means of Short Messages sent from the receiver. Again, due to the large amount of information and the need to include both the issuer's and the receiver's signatures, the request message has to be sent as three short messages. The first SM contains the cheque information and the next two short messages contain the signatures of the receiver and the issuer respectively. To be able to associate the messages again on the receiver's side each message must contain a reference to the other parts of the message; this parameter is called the MessageReference and is a one-byte counter that is unique for each user.

It is well known to use mobile telephones provided with IrDA, fast IrDA or Bluetooth facilities to withdraw money from Automatic Teller Machines ATM. If the electronic payment cheque service is implemented in the SIM card of a mobile telephone with the IrDA, fast IrDA or Bluetooth facility, the mobile telephone can be used to withdraw the amount of money in the electronic payment cheque by means of an ATM. Moreover, the user could choose to withdraw some of the amount of money indicated in the electronic payment cheque from the ATM and deposit the remaining part of the amount into an account.

In general, it should be noted that point-to-point communication between a mobile station (mobile telephone) and another mobile station also could be in accordance with the IrDA or fast IrDa standard, the Bluetooth standard, Wi-Fi standard and/or any other near-range communication standard.

1. A method of processing en electronic payment cheque that relates to a transfer of an amount of money from an account of a first user in a first banking institute (500) to an account of a second user in a second banking institute (550), which processing includes generating digital signatures by means of asymmetric encryption using en asymmetric key pair comprising a private key and a public key, characterized in that, the method comprises the following steps:
in a first SIM card (101a) of the first user, creating an electronic payment cheque and signing the electronic payment cheque with a first signature generated by means of a first private key of a first asymmetric key pair, which first private key is generated on the first SIM card (101a) and resides on the first SIM card (109a) hosted by a first mobile equipment (101b),
via the first mobile equipment (10b) hosting the SIM card (101a) of the first user, transmitting the signed electronic payment cheque to a second SIM card (102a) hosted in a second mobile equipment (102b) of the second user,
in the second SIM card (102a), signing the electronic payment cheque, which has been signed with the first signature, with an additional second signature generated on the second SIM card (102a) by means of a second private key of a second asymmetric key pair, which second private key is generated on the second SIM card (102a) and resides on the second SIM card (102a) hosted by the second mobile equipment (102b),
transmitting the electronic payment cheque signed with the first and the second digital signatures from the second mobile equipment (102b) to a central hub (300), which central hub (300) is in communication with the first and the second banking institutes (500, 550),
in the central hub (300), initiating a deposit of the amount of money in the electronic payment cheque into the account of the second user by initialising a verification of the second signature at the banking institution (550) of the second user and a verification of the first signature at the banking institution of the first user (500).

2. Method according to claim 1, wherein the transmittal of the signed electronic payment cheque from the first mobile equipment (101b) hosting the SIM card (101a) of the first user to the second SIM card (102a) hosted in a second mobile equipment (102b) of the second user, is performed via a digital mobile telephone system.

3. A method according to claim 1, wherein the signed payment cheque is transmitted as a Short Message by means of the Short Message Servicesystem over the GSM system.

4. A method according to claim 1, wherein the signed payment cheque is transmitted as a Short Message by means of lr, Bluetooth or Wi-Fi standards.

5. A method according to claim 1, wherein creating of an electronic payment cheque comprises indicating a telephone number associated to the second SIM card (102a), an amount to be transferred and an index to the account, wherefrom the amount should be withdrawn.

6. A method according to claim 1, wherein the method further comprises:
via the first mobile equipment (101b), prompting the first user to confirm creation of an electronic payment cheque, which prompting is initiated at the first SIM card (101a) hosted by the first mobile equipment (101b).

7. A method according to claim 6, wherein the conformation comprises entering of a PIN-RSA number.

8. A method according to claim 1, wherein the encrypted electronic payment cheque is transmitted via a message proxy in the central hub (300).

9. A method according to claim 8, wherein the encrypted electronic payment cheque at the message proxy is converted to an SMS Point to-point data download message, which subsequently is transmited to the second SIM card hosted by the second mobile equipment.

10. A method of issuing an electronic payment cheque that relates to a transfer of an amount of money from an account of a first user in a first banking institute (500) to an account of a second user in a second banking institute (550), which issuing includes generating a digital signature by means of asymmetric encryption using an asymmetric key pair comprising a private key and a public key, characterized in that, the method comprises the following steps:
in a first SIM cad (101a) of the first user, creating an electronic payment cheque and signing the electronic payment cheque with a first signature generated by means of a first private key of a first asymmetric key pair, which first private key the first private key is generated on the first SIM cad (101a) and resides on the first SIM card (101a) hosted by a first mobile equipment (101b),
via the first mobile equipment (101b) hosting the SIM cad (101a) of the first user, transmitting the signed electronic payment cheque to a second SIM cad (102a) hosted in a second mobile equipment (102b) of the second user.

11. Method according to claim 10, wherein the transmittal of the signed electronic payment cheque from the first mobile equipment (101b) hosting the SIM card (101a) of the first user to the second SIM card (102a) hosted in a second mobile equipment (102b) of the second user, is performed via a digital mobile telephone system.

12. A method according to claim 10, wherein the signed payment cheque is transmitted as a Short Message by means of the Short Message Service system over the GSM system.

13. A method according to claim 90, wherein the signed payment cheque is transmitted as a Short Message by means of lr, Bluetooth 10 or Wi-Fi standards.

14. A method according to claim 10, wherein creating of an electronic payment cheque comprises indicating a telephone number associated to the second SIM card (102a), an amount to be transferred and an index to the account, wherefrom the amount should be withdrawn.

15. A method according to claim 10, wherein the signed electronic payment cheque is transmitted via a message proxy.

16. A method according to claim 15, wherein the signed electronic payment cheque at the message proxy is converted to an SMS Point-to-point data download message, which subsequently is transmitted to the second SIM card (102a) hosted by the second mobile equipment (102b).

17. A method of depositing a received electronic payment cheque that relates to a transfer of an amount of money from an account of a first user in a first banking institute (500) to an account of a second user in a second banking institute (550), which processing includes generating digital signatures by means of asymmetric encryption using an asymmetric key pair comprising a private key and a public key, characterized in that, the method comprises the following steps:
in the second SIM card (102a), signing the received electronic payment cheque, which has been signed with a first signature, with an additional second signature generated on the second SIM card (102a) by means of a second primate key of a second asymmetric key pair, which second private key is generated on the second SIM card (102a) and resides on the second SIM card (102a) hosted by the second mobile equipment (102b),
transmitting the electronic payment cheque signed with the first and the second digital signatures from the second mobile equipment (102b) to the central hub (300), which central hub (300) is in communication with the first and the second banking institutes (500, 550),
in the central hub (300), initiating a deposit of the amount of money in the electronic payment cheque into the account of the second user by initialising a verification of the second signature at the banking institution (550) of the second user and a verification of the first signature at the banking institution (500) of the first user.

18. A method according to claim 17, wherein the signed received payment cheque is transmitted as a Short Message by means of the Short Message Service system over the GSM system.

19. A method according to claim 17, wherein the signed received electronic payment cheque is transmitted via a message proxy in the central hub (300).
